(19) United States
(12) Patent Application Publication
(10) Pub. No.: US 2002/0098891 A1
(43) Pub. Date: Jul. 25, 2002

(54) Computerized system and method for providing advertising to a consumer

(76) Inventors: Michael B. Graham, Cincinnati, OH (US); John A. Woffington IV, Cincinnati, OH (US); Steven P. Wolf, Cincinnati, OH (US)

Correspondence Address: David A. Mancino, Esq., Taft, Stettinius & Hollister LLP, Suite 1800, 425 Walnut Street, Cincinnati, OH, 45202-3957, US

(21) Appl. No.: 09/945,378

(22) Filed: Aug. 31, 2001

Related U.S. Application Data
(60) Provisional application No. 60/238,776, filed on Oct. 10, 2000.

(51) Int. Cl. A63F 13/00

(52) U.S. Cl. 463/42

(57) ABSTRACT

A system and method enables the development and deployment of tailored advertising-messages to consumers utilizing electronic media by integrating advertising messages and equity images into an electronic game, the actions of which are varied as the game is played, based upon the consumer's interaction with the game. The advertising messages are delivered, and useful data is collected, providing puzzles that are about, and centered around, the advertisements and commercial entity's brands themselves. The flow of the game may be based upon predefined rules set up by the commercial entity. In an exemplary embodiment, the invention resides on an Internet server and provides an on-line game to consumers accessing the server over the Internet; players provide certain demographic data before the gaming starts; then the commercial entity's brands and advertising messages are incorporated into the game based upon the players' answers. Furthermore, in this exemplary embodiment, the flow of the game is determined, at least in part, upon the players' knowledge/perception of a commercial entity's brand, logos, tag-lines, products, competitors, and the like. As the invention learns more about each individual consumer playing the on-line game (as a result of the invention gathering demographic data and game playing performance data), the invention is able to tailor an advertising strategy towards that particular consumer as the game goes on.

### CROSS REFERENCE TO RELATED APPLICATIONS

The present application claims the benefit of U.S. Provisional Patent Application, Ser. No. 60/238,776, filed Oct. 10, 2000.

### BACKGROUND

The present invention is directed to a system and method for providing advertising to a consumer utilizing electronic media; and more particularly, to a computerized system and method for providing advertising to a consumer and/or for gathering statistical data from the consumer associated with a commercial entity's products and/or services.

Conventional advertising methods and systems utilizing electronic media have many well known disadvantages. For example, television advertising may experience difficulties with viewers “channel-surfing” during the advertising commercials that are displayed in the breaks between television programs and/or segments of the television programs. Additionally, the types of ads presented on the television are typically tailored to the consumer based upon the type of television programs that is being presented in the particular time slot. For example, children's television programs will particularly be accompanied by advertisements of children's products. Likewise, most sporting events will particularly be accompanied by advertisements geared toward young to middle aged males. While such advertisements are especially tailored to communicate with a majority (it is hoped) of the viewers, the advertisements would certainly not be appropriate or tailored for all of the viewers.

On-line advertisements, such as banner advertisements on the World-Wide Web, experience a common problem in that they are often ignored. Some on-line advertisements are attempting to overcome this apathy integrating the advertisements within on-line games. For example, most of the advertising on gaming sites include banners that appear within the viewing area of the games, but are not part of the games themselves; and other advertisements may appear before or after the consumer has played the game or in “pop-up” windows during, or after play. Therefore, the advertisers are hoping that, while the users are playing the games, the user will, at some point, feel compelled to view the advertisements.

A disadvantage with all of this advertising utilizing electronic media is that the advertisers gain very little knowledge and feedback with respect to the effectiveness of the advertisements. For television advertising, as an example, such feedback data can only be provided by television ratings and/or surveys presented to the viewers (such as annoying telephone surveys). For on-line advertising, as an example, such feedback data can be provided by a count of the number of consumers that accessed the on-line add (“click-through” counts) as well as by obtaining survey data. Another disadvantage with the conventional electronic media advertising methods is that the message delivered is not able to be varied in real-time, based upon the viewer's perception/knowledge/experience of the commercial entity's products and brands and/or based upon the viewer's demographics.

### SUMMARY OF THE INVENTION

The present invention involves a system and method that enables the development and deployment of tailored advertising-messages to consumers utilizing electronic media. The invention involves the integration of media and advertising messages into an electronic game, the actions of which are varied in real-time based upon the consumer's interaction with the games and messages. The advertising messages are delivered, and useful data is collected, through games and puzzles about the advertisements and commercial entity's brands themselves. The flow and/or content of the game may be based upon predefined rules set up by the commercial entity.

In an exemplary embodiment, the invention resides on an Internet server and provides an online game to consumers accessing the server over the Internet. In this exemplary embodiment, players are asked demographic questions and are asked to provide certain demographic data before the gaming starts. Then the commercial entity's brands and advertising messages are incorporated into the game based upon the players' answers. Furthermore, in this exemplary embodiment, the flow and/or content of the game is determined, at least in part, upon the players' knowledge/perception of a commercial entity's brand, logos, tag-lines, products, competitors, and the like. For example, in some instances, the players may be quizzed on commercials, taglines and jingles. As the invention learns more about each individual consumer playing the on-line game (as a result of the invention gathering demographic data and game playing performance data), the invention is able to tailor an advertising strategy towards that particular consumer as the game goes on. The result of this targeted advertising strategy may be presented, for example, to the player during the course of the game itself, in the form of separate advertising messages delivered during or after the game, or in the form of gifts and/or offers to the player.

The exemplary embodiment of the invention collects performance data and demographic data as the game goes on and the commercial entity who owns the brands being advertised will later be able to review statistical reports generated by this data. For example, the commercial entity will be able to know how many and what type of consumers viewed the particular advertisements; and since many of the games played test the consumers knowledge and perceptions of the commercial entity's brands, these reports will also provide information to the commercial entity regarding the players' perceptions of the commercial entity and its brand equity, and can even compare the commercial entity's brand equity against its competitors.

Therefore, a first aspect of the present invention is directed to a computerized method for providing advertising to a consumer and/or for gathering statistical data from the consumer associated with a commercial entity's products and/or services. The computerized method includes the step of providing a computerized game to a consumer, where the game includes the step of testing the consumer's ability to recognize a marketing object associated with a commercial entity. This marketing object may be, for example, the commercial entity's logo, the commercial entity's trademark, the commercial entity's trade name, the commercial entity's tagline, the commercial entity's product name, a competitor's logo, a competitor's trademark, a competitor's trade name, a competitor's tagline or a competitor's product name. In a detailed embodiment, the marketing object may be presented with a television commercial, or a video segment from a television commercial.

In a more detailed embodiment of this first aspect of the present invention, the testing step includes the step of providing a computerized puzzle for the consumer to solve. Such puzzle may be, for example, in the form of a fill-in-the-missing-letters typed word game, and unscramble-the-letters type word game, a multiple-choice type question, a true-false type question, a fill-in-the-blank type question, a game testing the consumer's ability to assemble a finished image from a plurality of scrambled partial images, a game testing the consumer's ability to recognize a marketing object from a partial image of the marketing object, a concentration style memory matching game, or a game testing the consumer's ability to recognize marketing objects associated with the commercial entity versus marketing objects not associated with the commercial entity. The multiple-choice or true-false question, for example, may be presented during or after a video segment of a television commercial is displayed to the consumer. In a more detailed embodiment, the game includes a plurality of the computerized puzzles and the consumer is provided with a series of the plurality of the computerized puzzles. And in yet a further detailed embodiment, the game includes the step of selecting a next of the plurality of puzzles in the series to be provided to the consumer based, at least in part, upon the performance of the consumer in one or more of the previous puzzles and/or upon demographic information of the consumer and/or upon brand-related data provided by the consumer. And in yet a further detailed embodiment, the method further includes the step of storing the puzzle-solving performance of the consumer for the purpose of statistical analysis and/or report generation.

In an alternate detailed embodiment of the first aspect of the present invention, the method further includes the step of delivering one of a plurality of marketing messages to the consumer or customizing the information provided in the marketing message provided to the consumer based, at least in part, upon the puzzle solving performance of the consumer and/or upon demographic information of the consumer and/or upon brand-related data provided by the consumer. In another alternate detailed embodiment, the method includes the step of offering a coupon, a product sample, a loyalty program or a gift to the consumer based, at least in part, upon the puzzle solving performance of the consumer and/or demographic information of the consumer and/or brand-related data provided by the consumer.

In another alternate detailed embodiment of the first aspect of the invention discussed above, the method further includes the step of, upon a consumer failing to solve the puzzle, providing a correct answer along with one or more visual marketing messages, marketing images, audio marketing messages, and/or video of marketing messages.

In another alternate detailed embodiment of the first aspect of the present invention, the method provides the ability for the consumer to notify other consumers about the computerized game and assesses how viral the game is and/or how viral a marketing object is based, at least in part, upon how many other consumers have been notified.

It is a second aspect of the present invention to provide a computerized method for measuring a consumer's perception of a commercial entity's brand equity, logo, trademark, trade name, tagline, product name and the like. This computerized method includes the steps of providing a present interactive advertising message to the consumer; allowing the consumer to interact with the present interactive advertising message; and gathering data associated with the consumer's interactions with the present interactive advertising message.

In a more detailed embodiment of this second aspect of the present invention, the present interactive advertising message is provided to a computer accessible by the consumer, where the computer includes a display screen and a input device. In an alternate detailed embodiment, the present interactive advertising message is provided to an interactive communication device accessible by the consumer (such as, for example, an interactive television, a personal data assistant, a telephone, a computer game, and the like), where the interactive communication device has an associated input device. And yet another alternate embodiment, the method includes the step of obtaining demographic information pertaining to the consumer. In a more detailed embodiment, the step of providing the present interactive advertising message to the consumer includes the step of selecting the present interactive advertising message from a group of interactive advertising messages based, at least in part, upon at least a portion of the demographic information obtained for the consumer.

In a further detailed embodiment of this second aspect of the present invention, the method further includes the steps of: selecting a next interactive advertising message based, at least in part, upon at least a portion of the data associated with the consumer's interactions with the present interactive advertising message and/or the demographic information obtained for the consumer; and providing the next interactive advertising message to the consumer. In a further detailed embodiment, the method further includes the step of gathering data associated with the consumer's interactions with this next advertising message.

In an alternate detailed embodiment of the second aspect of the present invention, the present interactive advertising message is provided to the consumer within the context of an interactive game. In another alternate embodiment of the second aspect of the present invention, the method further includes the steps of selecting a next interactive advertising message based, at least in part, upon the consumer's interactions with the present interactive advertising message and providing the next interactive advertising message to the consumer. And in yet another alternate embodiment of the second aspect of the present invention, the step of gathering data associated with the consumer's interactions with the present advertising message includes the step of gathering data related to the consumer's awareness of the commercial entity's brand. And in yet another detailed embodiment of the second aspect of the present invention, the step of gathering data associated with the consumer's interactions with the present advertising message includes the step of gathering data related to the consumer's awareness of the commercial entity's product. And in yet another alternate embodiment of the second aspect of the present invention, the step of gathering data associated with the consumer's interactions with the present advertising message includes the step of gathering data related to the consumer's recall of the commercial entity's tagline. And in yet another alternate embodiment of the first aspect of the present invention, the step of gathering data associated with the consumer's interactions with the present advertising message includes the step of gathering data related to the consumer's recall of the benefits of the commercial entity's product/service. And in yet another alternate embodiment of the second aspect of the present invention, the step of gathering data associated with the consumer's interactions with the present advertising message includes the step of gathering data related to the consumer's image association with the commercial entity's brand equity. And in yet another alternate embodiment of the second aspect of the present invention, the step of gathering data associated with the consumer's interactions with the present advertising message includes the steps of gathering data related to the consumer's language association with the commercial entity's brand equity.

A third aspect of the present invention is directed to a computerized method for measuring the consumer's perception of the commercial entity's brand equity, logo, trademark, trade name, tagline, product name and the like. This method includes the steps of providing an interactive puzzle to a user's computer terminal having at least a display and a user-controlled input device, where the interactive puzzle tests the user's perception regarding a commercial entity's brand equity, a commercial entity's logo, a commercial entity's trademark, a commercial entity's trade name, a commercial entity's tagline, a commercial entity's product name, benefits of a commercial entity's product, a commercial entity's service name, and/or benefits of a commercial entity's service; monitoring the user's interactions with the interactive puzzle; and based upon the user's interactions with the interactive puzzle, performing the step of providing a next interactive puzzle to the users computer or performing the step of providing an advertising message to the user's computer, or performing the step of offering to the user a coupon, a product sample, a loyalty program and/or a gift.

In a more detail embodiment of this third aspect of the present invention, the interactive puzzle is either a fill-in-the-missing-letters type or game or an unscramble-the-letters type word game. And yet a further detailed embodiment of this third aspect of the present invention, the word game operates according, at least in part, to the step of providing a plurality of phrases consisting of at least one word for the user to fill-in or unscramble, respectively, where at least one of the phrases corresponds to the commercial entity and where at least one other of the phrases corresponds to a competitor of the commercial entity. And in yet a further detailed embodiment, the plurality of the phrases may include different brands in a category of product/services; or, alternatively, the plurality of phrases may include different products in a product line.

In yet another alternate detailed embodiment of the third aspect of the present invention, the interactive puzzle operates, at least in part, according to the steps of displaying one or more items to the user and querying the user whether or not the item pertains to the commercial entity. In a more detailed embodiment, the item displayed to the user is a phrase consisting of one or more words. And in yet a further detailed embodiment, the phrase is a trademark, a service mark, a product name, a service name, and/or tagline of the commercial entity. Alternatively, the item displayed may be an image, where the image is either a commercial entity's logo, a product of the commercial entity and/or an equity image pertaining to the commercial entity.

In another alternate detailed embodiment of the third aspect of the present invention, the interactive puzzle operates at least in part, according to the step of providing a question to the user. In an even more detailed embodiment, the operation of the puzzle further includes the step of providing audio message, a video message and/or an image to the user and a question provided to the user pertaining to the audio, video or image provided. In a more detailed embodiment, the audio message, video message and/or image presented is an advertisement; or, alternatively, the audio message, video message and/or image is a partial segment of a complete audio message, video message and/or image.

### BRIEF DESCRIPTION OF THE DRAWINGS

FIG. 1 is a schematic block diagram representation of an electronic media system for use with an exemplary embodiment of the present invention;

FIG. 2 is a flow diagram illustrating a method of operation for an interactive advertising game according to an exemplary embodiment of the present invention;

FIG. 3 is an example screen shot of a demographic data form according to an exemplary embodiment of the present invention;

FIG. 4 is an example screen shot of an interactive puzzle according to an exemplary embodiment of the present invention;

FIG. 5 is an example screen shot of another interactive puzzle according to an exemplary embodiment of the present invention;

FIG. 6 is an example screen shot of an incorrect answer display according to an exemplary embodiment of the present invention;

FIG. 7 is an example screen shot of another interactive puzzle according to an exemplary embodiment of the present invention;

FIG. 8 is an example screen shot of another interactive puzzle according to an exemplary embodiment of the present invention;

FIG. 9 is an example screen shot of another interactive puzzle according to an exemplary embodiment of the present invention;

FIG. 10 is an example screen shot of another interactive puzzle according to an exemplary embodiment of the present invention;

FIG. 11 is an example screen shot of another interactive puzzle according to an exemplary embodiment of the present invention;

FIG. 12 is an example screen shot of a prize offer display according to an exemplary embodiment of the present invention;

FIG. 13 is a flow diagram illustrating an example game flow that may be defined by a company utilizing the exemplary embodiment of the present invention;

FIG. 14 is an example screen shot of a top level game flow definition form according to an exemplary embodiment of the present invention;

FIG. 15 is an example screen shot of a main puzzle definition form according to an exemplary embodiment of the present invention;

FIG. 16 is an example screen shot of a puzzle details form according to an exemplary embodiment of the present invention;

FIG. 17 is an example statistical report provided by an exemplary embodiment of the present invention;

FIG. 18 is another example statistical report provided by an exemplary embodiment of the present invention; and

FIG. 19 is another example statistical report provided by an exemplary embodiment of the present invention.

### DETAILED DESCRIPTION

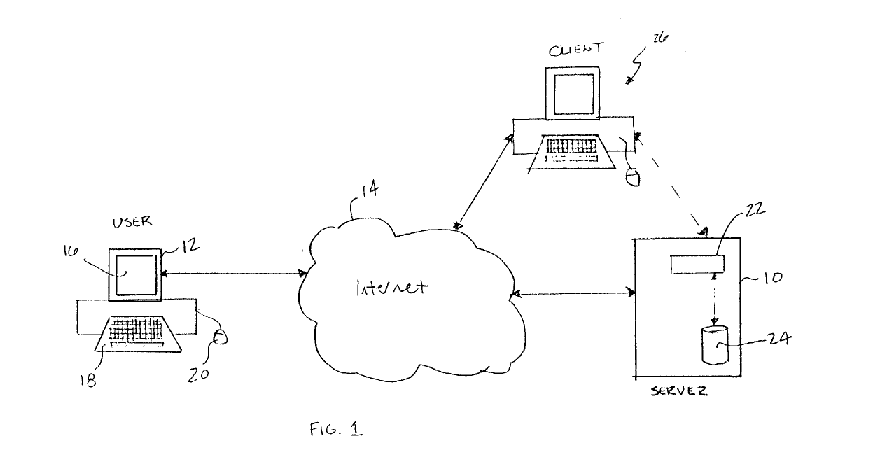

As shown in FIG. 1, an exemplary embodiment of an electronic media system for delivering the methods according to the present invention to the user involves a computer server 10 delivering the interactive games to a user's remote computer 12 over the Internet 14 or over another computer network. The user's computer will include a display 16 for displaying graphical images and/or videos involved with the interactive game and one or more input devices such as a keyboard 18 or a mouse 20 for interacting with the interactive game. As will be apparent to those of ordinary skill, other sorts of input devices may also be utilized without departing from the scope of the invention, such as touch screens, microphones, joysticks, game pads, and the like. The server includes memory 22 for containing the operational software controlling the operation of the interactive game. More specifically, in this exemplary embodiment, the software resident on the memory 22 controls the delivery of graphical interface and display code (such as HTML, JAVA, video, sound and the like) to the user's computer 12 for display on the user's computer; and, likewise, controls the receipt of the interactive data provided back by the user's computer 12 to the server. The server also includes (or has access to) a database 24 for storing data related to the user and the user's interactions with the interactive games. Such data will be described in further detail below.

The present invention also provides for the use of a client terminal or computer 26 that may communicate with, or be operatively coupled to, the server 10 over the Internet or by direct connection. The client computer 26, as will be discussed below, may be used to design, control and/or monitor the interactive games provided by the server 10.

While the exemplary embodiment from the present invention is provided to the user over the Internet, it will be appreciated by those of ordinary skill in the art that other forms of electronic media may be used while remaining within the scope of at least certain aspects of the present invention. Examples, without limitation, of such electronic media includes interactive television, dedicated electronic gaming systems, handheld devices such as personal data assistants (PDAs), telephones, and the like. It is also within the scope of the invention that the interactive game can be provided on a stand alone computer. For example, the game can be contained within a kiosk (containing both the operations of the server 10 and the user's computer 12) placed in a public location so that users attracted to the kiosk can play the advertising games resident thereon. As another example, the advertising game could be resident upon a memory device (such as a CD ROM) that could be distributed to consumers so that the consumers can play the advertising game on their personal computers. If the game is distributed to consumers in such a manner, it may not be necessary to collect performance and/or demographic data of the consumer on a separate database for later processing. Alternatively, the CD ROM-based game may include operations for linking the user's computer to a server over the Internet or some other network so that the server may collect statistical data and/or control certain operations of the game. At this point it will be appreciated by those of ordinary skill in the art that the manner in which the interactive game is delivered to the consumer is not critical according to many aspects of the present invention; and the inventions described and claimed herein are not to be limited to any particular system of delivery, unless expressly claimed otherwise.

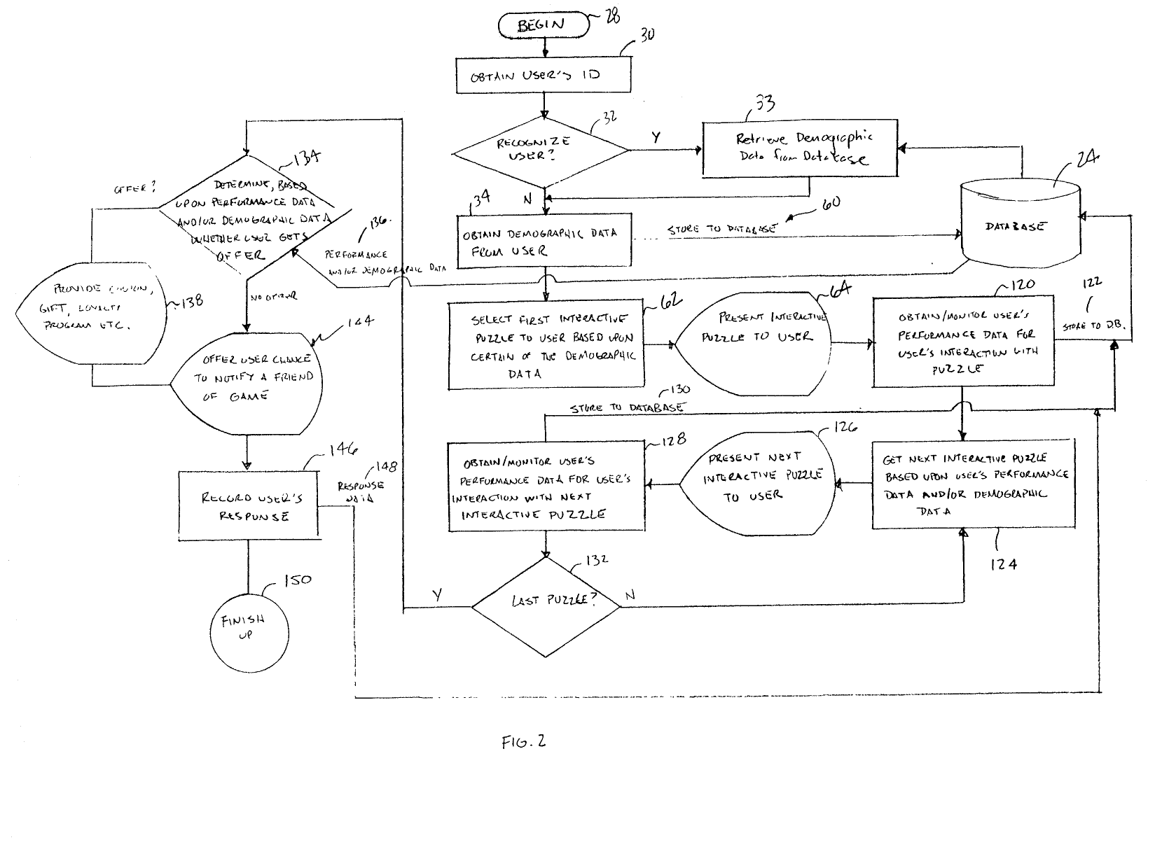

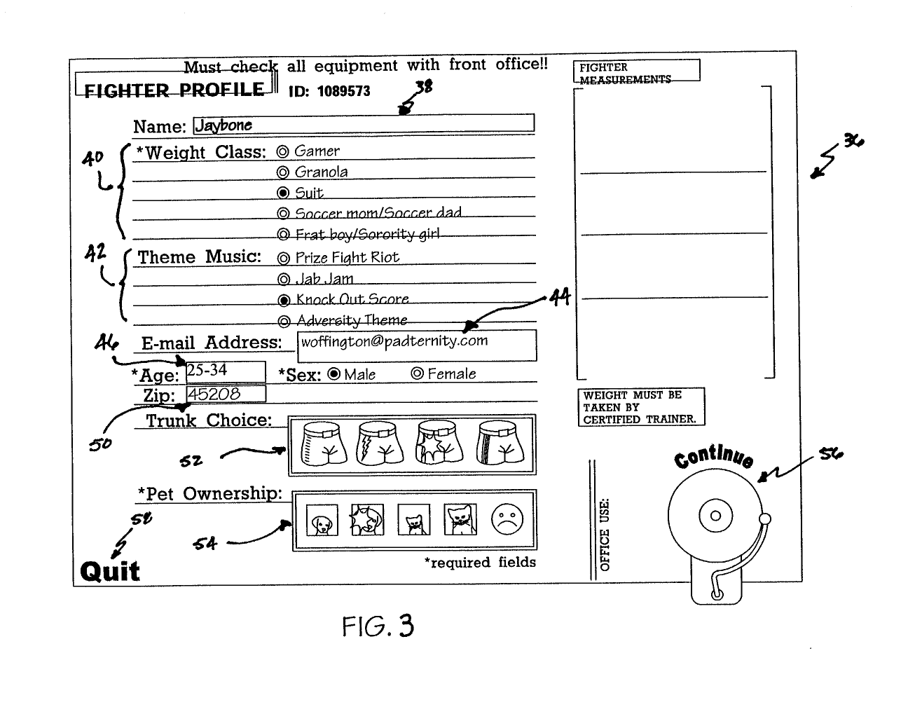

FIG. 2 illustrates a flow diagram that represents the operation of the interactive game according to an exemplary embodiment of the present invention. In discussing this flow diagram, FIGS. 3-12 will be referred to as providing example screen displays as viewed by the consumer. The attractiveness of the game may be increased if the game is centered around a common theme, such as a boxing match theme as shown in the screen shots of FIGS. 3-12. Video, music, commentary, sound-effects, graphics and the like may be incorporated as desired to also contribute to the attractiveness of the game.

Referring to FIG. 2, the process is joined at step 28. Advancing to step 30, the interactive game obtains user identification data. This identification data can be transmitted to the game in a number of manners. For example, in the exemplary embodiment, the user's identification can occur during a log-on operation where the user enters his or her name or moniker into the system. Alternatively, the exemplary embodiment, the user's computer may contain “cookies” recognized by the game, which indicates that the user had logged on to the game previously and that the game had stored the cookies on the user's computer.

Advancing to step 32 the game determines if it recognizes the user. As will be appreciated by those of ordinary skill in the art, there are many diverse methods for the game to determine if it recognizes the user, all of which are within the scope of the present invention. In the exemplary embodiment, after a user first accesses the game, the game will cause certain codes and data (in the form of “cookies”) to be stored on the user's computer 12. Thereafter, when the user accesses the game utilizing the computer 12, the game will review the cookies stored on the user's computer to identify/recognize the user. Once recognized, the game will utilize the user's identification data to reference a database entry for the user in the database 24 and retrieve the user's demographic and prior performance data from the database as shown in step 33. From this step, the game advances to step 34, where the game obtains additional demographic data from the user, or where the game provides a form that allows the user to change or modify some of the demographic data previously stored in the database 24. If the user is not recognized in step 32, the game then advances to step 34 to obtain demographic data from the user.

FIG. 3 illustrates an exemplary embodiment of a form 36 provided to the user to obtain demographic data from the user and/or allow the user to modify certain demographic data. As shown in FIG. 3, the form 36 requests “weigh-in” information consistent with the overall boxing match theme. The form includes a field 38 where the user is asked to enter in a name or moniker, a field 40 where the user is asked to select a weight-class, a field 42 where the user is asked to select a theme music, a field 44 where the user is asked to enter an e-mail address, a field 46 where the user is asked to enter or select the user's age range, a field 48 where the user is asked to select the user's sex, a field 50 where the user is asked to enter a zip code, field 52 where the user is asked to select a trunk color, and a field 54 where the user is asked to select what type of pet (if any) the user owns. The form 36 also provides a “continue” icon/button 56 to indicate that the form has been completed and a “quit” icon/button 58 that the user can activate to quit the game. The weight class field 40, age field 46 and pet ownership field 54 are indicated as being required fields. As can be seen, the weight class fields is not asking for the user's weight, but is asking the user to categorize the user as falling within one of five categories: a “gamer” (intended to correspond to an avid game player—typically a younger individual), a “granola” (intended to correspond to an environmentally conscious indvidual), a “suit” (intended to correspond to a white collar professional), a “soccer mom/soccer dad” (intended to correspond to a parent of children) and a “frat boy/sorority girl” (intended to correspond to a college student). In the exemplary embodiment, the weight class and age fields are used by the game to tailor the flow of the game and the advertising messages used by the game for the particular type of person playing the game. For example, a “soccer mom/soccer dad” may be more interested in advertising pertaining to a spot-removing enhancement for a detergent (and, likewise, the advertiser may be more interested in advertising this type of product to this type of consumer) and a “frat boy/sorority girl” may be more interested in advertising pertaining to an easy-to-use detergent. Similar uses may be made for the age group of the user (advertisers may want to segment users and what advertising messages/puzzles they see/solve based upon their age), the pet ownership of the user (offer a coupon for dog-food at the end of the game) and for the other demographic fields. Once the data is provided into and accepted by the form 36, the game stores the new and updated data in the user's database record in the database 24 (see step 60 in FIG. 2).

While the exemplary embodiment of the “weigh-in” screen is presently arranged to obtain demographic data from the consumer, it is within the scope of the invention that this question form may also seek brand-related data from the user along with the demographic data. For example, the form may ask the user what brand of dog food he/she feeds his/her dog. As will be appreciated by those of ordinary skill in the art, the flow and/or content of the game may be varied depending upon the user's answers to such brand-related questions in much the same manner as the flow and/or content of the game may be varied depending upon the user's answers to the demographics-related questions.

Referring back to FIG. 3, the game will advance from step 34 to step 62 in which the game will select the first interactive puzzle to be provided to the user. In the exemplary embodiment, this first interactive puzzle is selected based upon some of the demographic data provided by the user. Alternatively, the first interactive puzzle may be selected based upon the prior performance (if any) of the user, a random selection, or based upon a combination of demographic, prior performance and/or random data. The first interactive puzzle may also be selected based upon a predetermined selection for all players. Advancing to step 64, the game will then present the first interactive puzzle to the user.

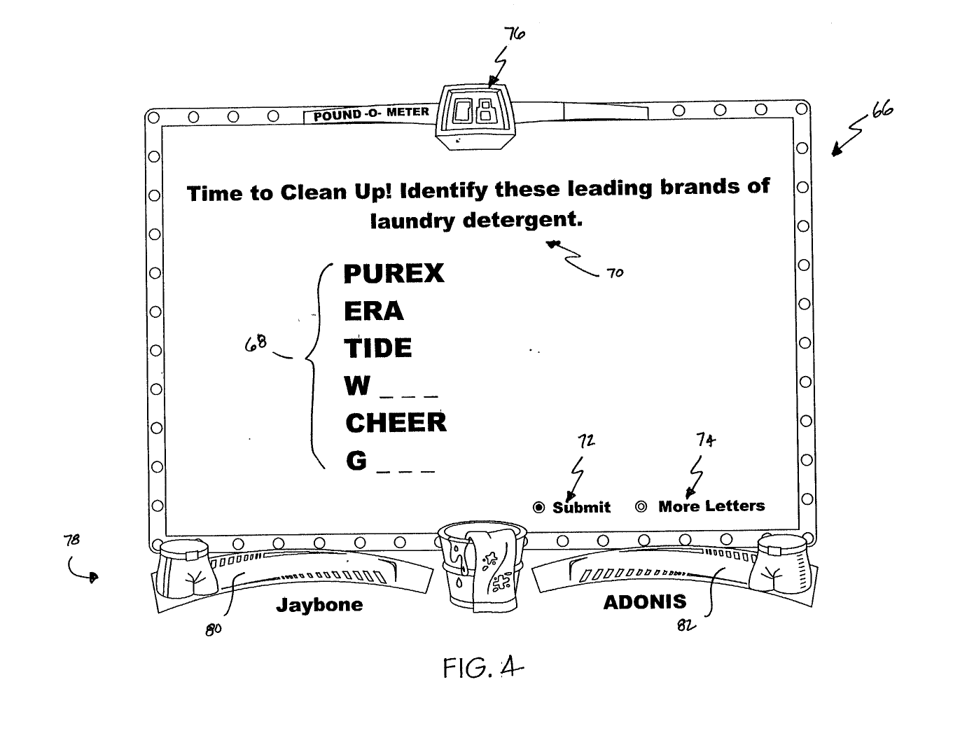

FIGS. 4-12 provide screen shots of certain interactive puzzles provided by the exemplary embodiment of the present invention. FIG. 4 provides an example of a fill-in-the-missing-letter type of puzzle 66. This particular puzzle 66, called “Aggro-Nym”, provides a number of fields 68 corresponding to different words (or phrases) where all or some of the letters are left blank for the user to fill in. In the exemplary embodiment, the words are different brand names of detergents, where the first letter is provided and the user tries to fill in the remaining letters. In this exemplary embodiment, therefore, the puzzle 66 can be used to determine the user's perception of a company's brand of detergent as well as the user's perception of the competitive brands. The flow of the game, the content of subsequent puzzles and other actions of the game may be immediately modified based upon the user's performance with this puzzle. Alternate uses for this puzzle may allow the game to test the user's perception of a certain product or products in a line of products; or any other particular thing or things in a category of things. In the exemplary embodiment, if the user gets any of the fields wrong or runs out of time the game will give the correct answers to the user. By doing this, the game may deliver or introduce the user to the particular brand name or may reinforce the user's perception of the brand.

Referring again to FIG. 4, the puzzle provides a display 70 informing the user the object of the puzzle, a “Submit” icon/button 72 in which the user will activate when the user believes the puzzle to be complete, and a “More Letters” icon/button 74 in which the user may ask for help from the game. Also provided is a display 76 of the time remaining to solve the puzzle and a display 78 providing the user's overall score at the present point (in the exemplary embodiment, the score is indicated as an indication of the health of the user's boxer 80 versus the health of the game's boxer 82).

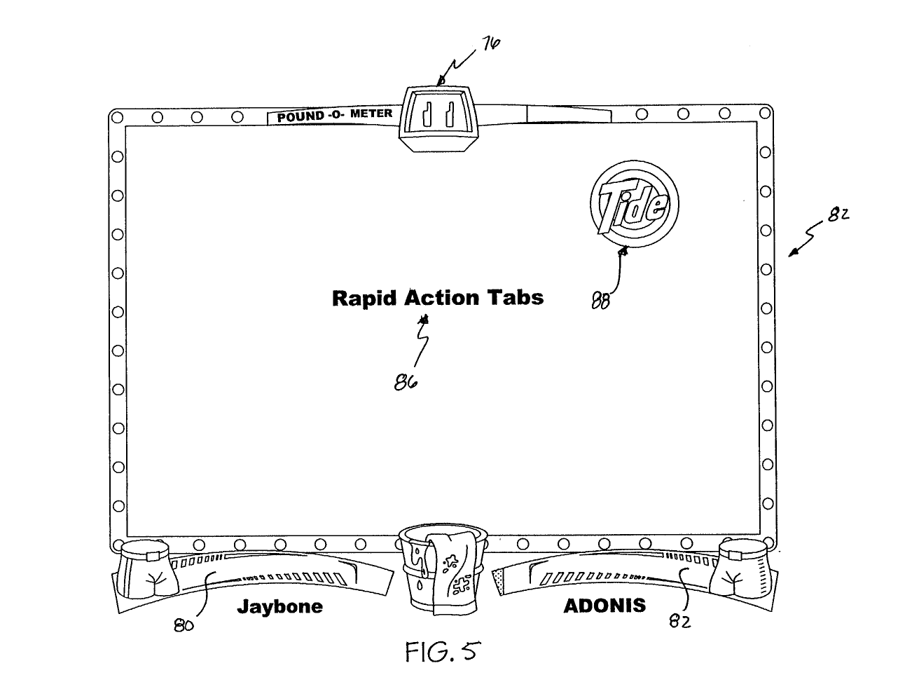

FIG. 5 provides an example of a puzzle 84 where the user tries to identify words, phrases or images associated with a commercial entity versus words, phrases or images not associated with the commercial entity. In the exemplary embodiment of the puzzle 84, called “Frontal Assault”, different words or phrases 86 will quickly cross the screen and the user has limited time to indicate whether or not the word or phrase 86 is associated with the brand 88. This puzzle is used to assess the user's perception of the brand and equity phrases associated with the brand. The flow of the game, the content of subsequent puzzles and other actions of the game may be immediately modified based upon the user's performance with this puzzle.

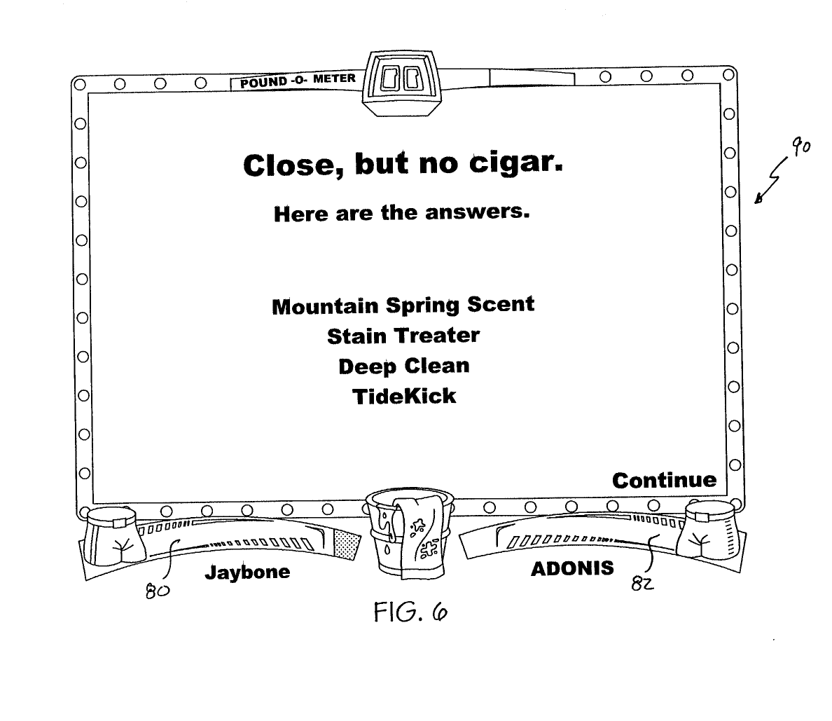

As shown in FIG. 6, in the exemplary embodiment, if the user fails to identify the words or phrases associated with the brand, or runs out of time, the game will give the correct answers to the user in an answer screen 90, and possibly, other messages or information to reinforce the brand and/or the brand equity. On the other hand, if the user successfully identifies the words or phrases associated with the brand, the game will provide a congratulatory screen to the user, along with the correct answers and, possibly, other reinforcing language for brand equity.

As will be appreciated by those of ordinary skill, the puzzle 84 may be used in a similar fashion to measure a user's recall of the commercial entity's tag line, the user's recall of the benefits of a commercial entity's product or brand, the user's ability to associate images associated with the commercial entity or with a brand of the commercial entity, and the user's ability to associate language with the commercial entity or the brand. Likewise, in the following “correct answers” display or “congratulatory” display the game will be able to reinforce the associated product benefits, tag lines, relevant image equity elements and/or relevant language equity elements.

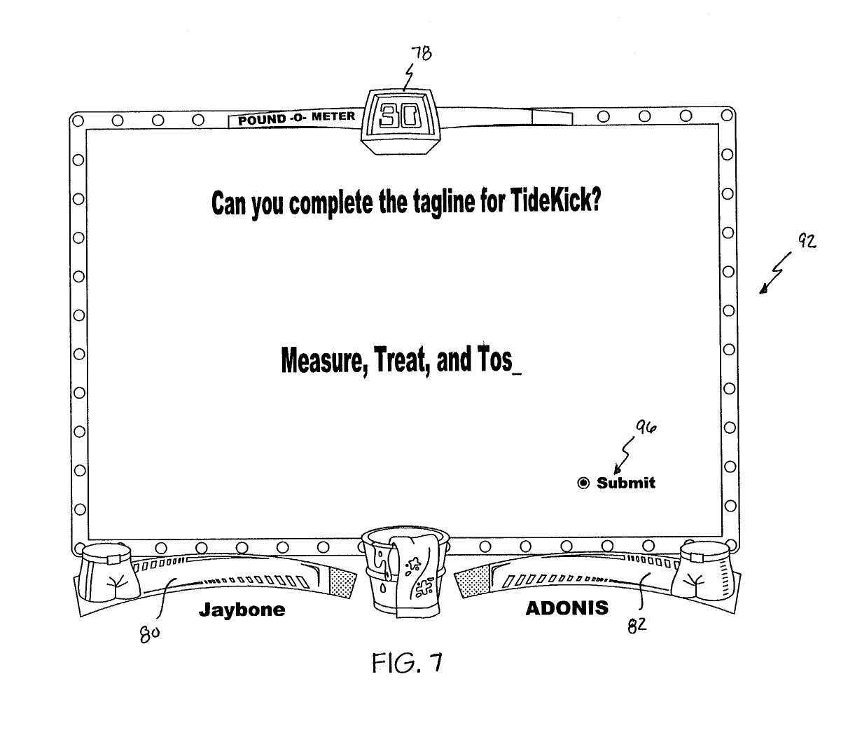

FIG. 7 provides another example of a fill-in-the-missing-letter type puzzle 92. This particular puzzle 92, called “Ad Lib”, provides a field 94 corresponding to the word or phrase associated with the company, such as a tag line, where all or some of the letters are left blank for the user to fill in. In the exemplary embodiment, the phrase is a tag line associated with the company and the puzzle 92 provides a limited number of the letters in the phrase to see if the user is able to recognize the tag line and fill in the remaining letters. As the time-remaining display 78 decrements towards zero, the game may provide additional correct letters to the phrase to make it easier as time progresses for the user to solve the puzzle. In this exemplary embodiment, therefore, the puzzle 92 can be used to determine the user's recall of the company's tag line. The flow of the game, the content of subsequent puzzles and other actions of the game may be immediately modified based upon the user's performance with this puzzle. In the exemplary embodiment, if the user is unable to complete the phrase in the allotted time, the game will give the correct answer to the user. By doing this, the game may deliver or introduce the user to the particular tag line or may reinforce the user's perception of the brand and/or tag line.

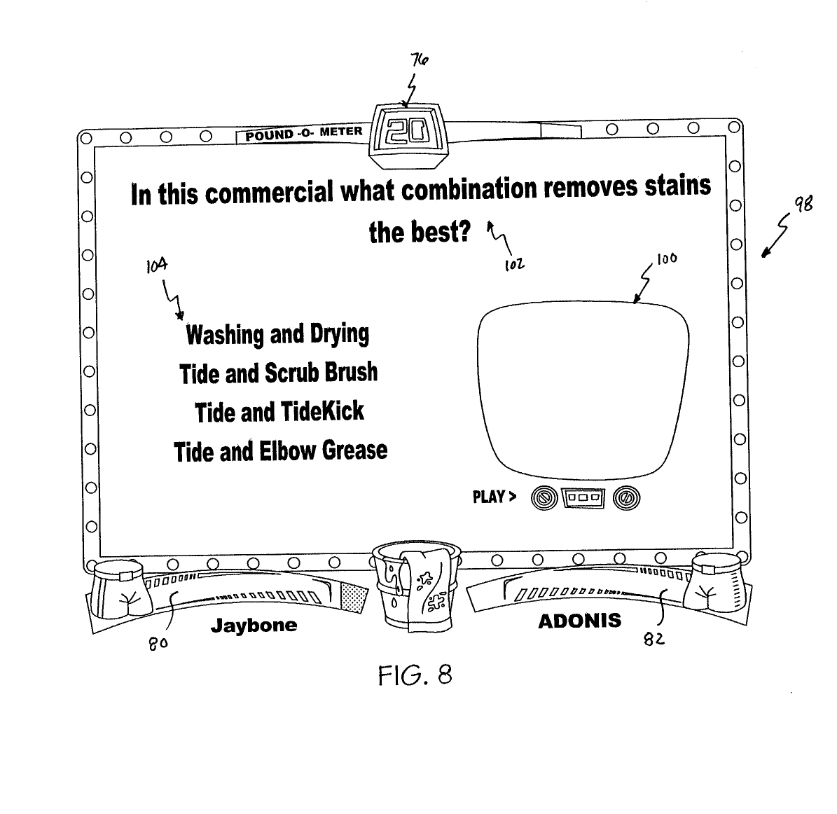

FIG. 8 provides an example of a puzzle 98 where the user is given a multiple-choice type question. In the exemplary embodiment of the puzzle 98, called “Pay Per View”, the game displays a video of a commercial on a video screen 100 and then asks a question 102 pertaining to the video, giving the user a number of multiple choice answers 104 to select. The Pay Per View puzzle is an example of a puzzle that is best utilized during advanced stages into the game where the game can tailor the commercial 100 to the user based upon the user's performance in solving previous puzzles and/or demographic data obtained for the user. The game can, therefore, provide different commercials to the user based upon these considerations and/or provide different questions to the users based upon these considerations. Although there are many measurements possible for this puzzle 98, the Pay Per View puzzle is best suited for measuring the user's recall of the benefits of a company's brand or product or, alternatively, the user's recall of a company's tag line. As with the other puzzles, once the user attempts to answer the question, the game will provide a correct answer screen or a congratulatory screen which may be used to reinforce the company's brand name, brand logo, relevant product names, tailored product benefits, tag lines, relevant image equity elements and relevant language equity elements. Additionally, by allowing the user to view the commercial prior or during the puzzle 98, the game is capable of providing a targeted commercial to the user based upon the user's awareness of the company's brands and/or products in combination with demographic information pertaining to the user.

As with the other puzzles provided by the game, the flow of the game, the content of subsequent puzzles and other actions of the game may be immediately modified based upon the user's performance with this puzzle.

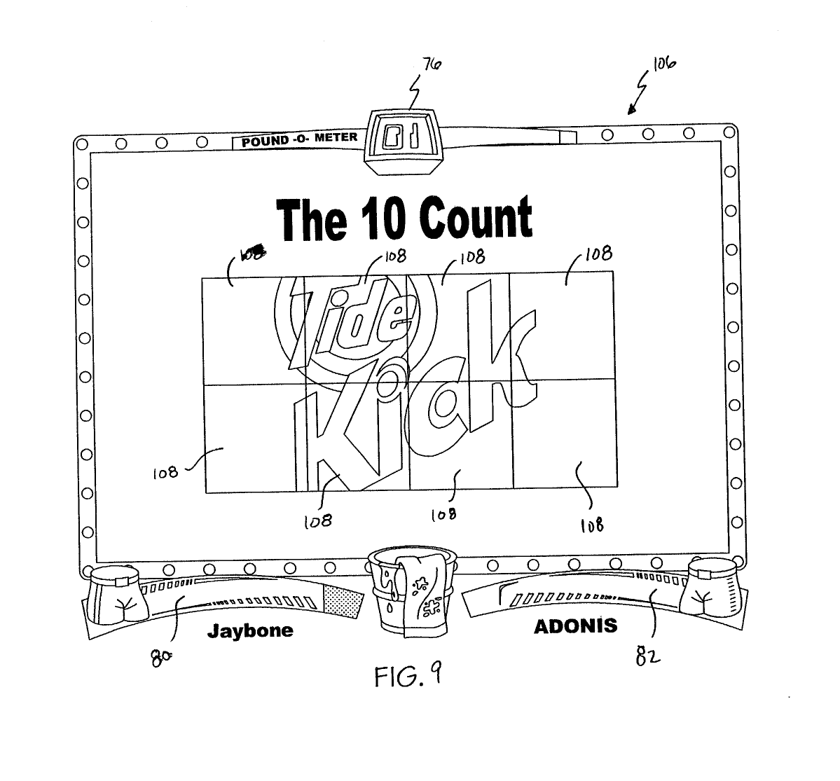

FIG. 9 provides an example of a puzzle 106 that is a concentration-type memory matching puzzle. In this puzzle 106, called “Ten Count”, the user is provided with eight squares 108 corresponding to four pairs of images randomly scrambled amongst each other. The images can be viewed by the user two at a time. The user will activate one of the hidden images and then attempt to find the matching image amongst the remaining hidden images by activating another hidden image where the user believes the matching image to reside. If the user is correct, both hidden images will remain displayed and the user will then try to match another pair of hidden images. If the user is incorrect, both selected images will be hidden again by the game and the user will again attempt to match a pair of the hidden images. The primary purpose for this game is to reinforce the company's logos and other key equity images associated with the company's brands and/or products.

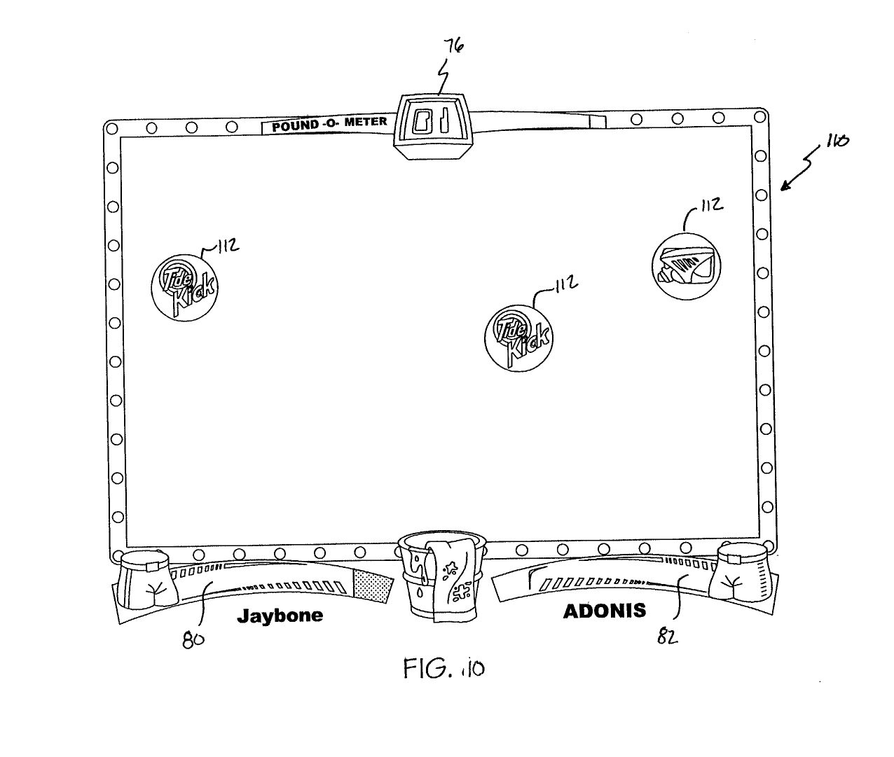

FIG. 10 provides an example of an action-type puzzle 110 where the user tries to activate images 112, using the mouse pointer, as they float through the screen. The primary purpose of this puzzle, called “Bob and Weave”, is to reinforce the company's logos and key equity images associated with the company's brands and products.

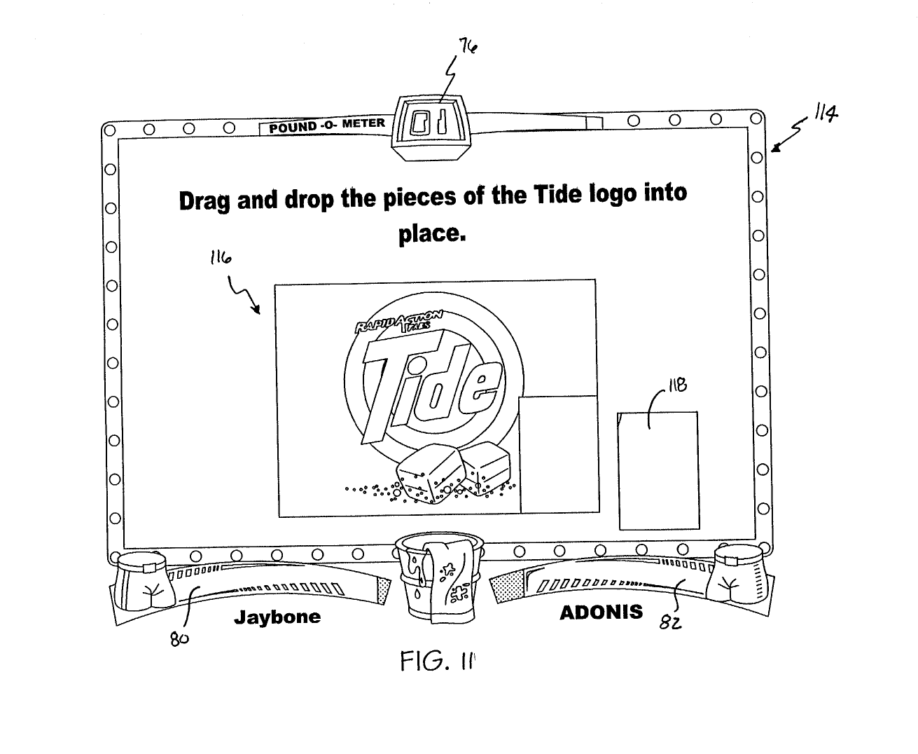

FIG. 11 provides an example of a puzzle 114 where the user attempts to construct an entire image 116 from a plurality of partial images 118, much like a jigsaw puzzle. The finished image 116 is preferably a company's logo or a key equity image associated with the company's brands and/or products. Therefore, this puzzle 114, called “Busted Up” is used to reinforce the company's logos and key equity images associated with the company's brands and/or products.

As will be apparent to those of ordinary skill in the art, there are many alternate styles of puzzles that may be used to measure the user's perceptions of a company's brands, logos, trademarks, trade names, tag lines, product names, and the like. There are also many different styles of puzzles that may be provided to the user to reinforce the user's perceptions of such things. One example of an alternate puzzle would be to provide a cliff-hanger type puzzle to the user, where the puzzle will first show a portion of the video to the user and then stop the video to ask the user a question regarding what will happen next in the video. Once the user attempts to answer the question, the video continues, thereby providing the user with the answer to that question. The primary benefits of this puzzle type are that it can be used to measure brand/product awareness, to reinforce the brand or product name, to reinforce the brand or product logo, to measure and/or reinforce the benefit of the product featured, and to measure and/or reinforce the main message of the television commercial.

Another example of an alternate puzzle type would be to provide a hidden image of a print ad or logo where the puzzle reveals portions of that hidden image, piece by piece, as time goes on. While this hidden image is being slowly revealed, a question related to the image is provided to the user. Upon the user attempting to answer the question or upon time running out, the user will be provided with the correct answer along with the complete image. The primary benefits of this puzzle type are that it can be used to measure awareness of imagery associated with the brand and to deliver that brand/associated image (or advertising) to the consumer.

Another example of a puzzle type for use with the present invention is to provide the user with an image of a single letter from a stylized trademark or logo associated with the letter based on how it looks (style, color, graphics, etc.). The full logo is presented on the answer screen after the user attempts to answer the question. This type of puzzle reinforces the brand logo.

Another example of a puzzle for use with the present invention is a range-finder type puzzle where the user is provided with a visual range-finder that is capable of moving up and down around a range of numbers. This type of puzzle can be used for any type of question that involves a number (for example, price, percent of Americans owning dogs, percent of Americans who shower every day, number of hamburgers served in the year, etc.). The answer screen highlights the correct answer and indicates whether or not the consumer “found the correct range”. This puzzle type can be used to reinforce numbers associated with the brand's equity.

Another example of a puzzle for use with the present invention is to provide the user with stills from television or print ads (or other images associated with the brand). The images are covered and revealed one at a time and the consumer is asked to guess the product within a certain time limit. This puzzle type can be used to measure the user's awareness of how well particular images are associated with a given brand. It also may deliver the messages contained in the standard television commercial.

Referring back to FIG. 2, it can be seen that once an interactive puzzle is first presented to the user as indicated in Step 64, the next step 120 is to obtain or monitor the user's performance data for the user's interaction with this first puzzle. As shown by Step 122, this performance data is preferably stored in the database 24. Advancing to Step 124, the next step is to get a next interactive puzzle based upon the user's performance in the previous puzzle(s) and/or based upon the user's demographic data. As shown in Step 126, this next puzzle is then presented to the user. As shown in Step 128, the game will obtain or monitor the user's performance data based upon the user's interaction with this next interactive puzzle. As shown in Step 130, such interaction data is preferably stored in the database 24. Advancing to Step 132, the game will next determine whether or not the previous puzzle provided to the user was the last puzzle. If not, the game will return to Step 124. If it is the last puzzle, then the game will advance to Step 134.

In Step 134, the game will determine, based upon the user's performance data and/or the user's demographic data whether or not the game will provide the user with an offer. This performance and/or demographic data is obtained from the database as shown in Step 136. If it is determined that the user is to receive an offer, the game advances to Step 138 to provide the user with a coupon, gift, loyalty program and the like. As will be appreciated by those of ordinary skill, this capability allows the company to establish a link between the company's advertising and the consumer's purchase behavior. Previously, consumers exposed to mass-advertising campaigns could not be directly connected to any behavioral outcomes associated with that exposure. This functionality allows the marketing professional to deliver promotions to the consumer based upon how the consumer interacts with the company's brands and/or based upon the consumer's demographics. For example, if a consumer has demonstrated strong knowledge of the company's brand, its benefits and its overall equity, the consumer can be served promotions that will reward and encourage loyalty, such as newsletter subscription or frequent buyer program membership. If the consumer is less knowledgeable about the brand, this consumer could be served a promotion such as a free sample or a coupon to encourage trial use. Additionally, the game can keep records in statistics based upon how many or the consumers offered with the coupon, gift, loyalty program, etc. accepted the offer. Such acceptance data could also be helpful in measuring the effectiveness of the company's ads and brand equity.

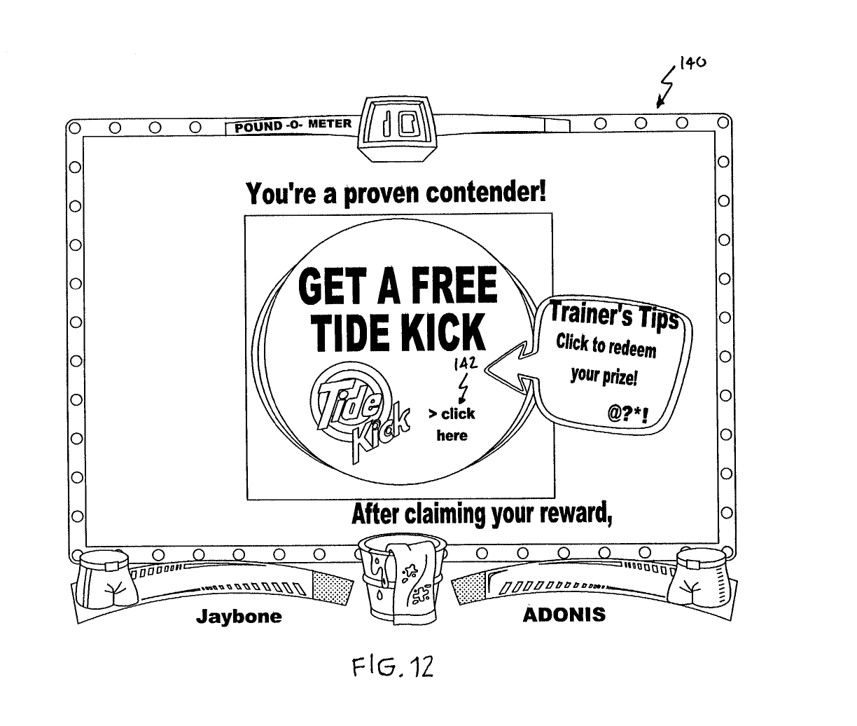

FIG. 12 provides an example screen in which the brand notifies the user that it is entitled to the offer. The offer includes a description of what offer the game is making to the consumer and a link or button 142 for the consumer to click on to obtain the offer. If the consumer accepts the offer (clicking on the button 142), in the preferred embodiment, a new browser window will be opened up that will take the consumer to the company's website, to a fulfillment partner website, or another site or application that asks the consumer additional questions. The end goal of any of these three options is to gather the required information for delivery of the promotion to the consumer (full name, address, e-mail address, etc.). Additionally, each of these options can also be used, at least in part, to gather additional information about the consumer so that future marketing efforts can be more directly targeted to that consumer. Once the consumer has finished providing such information, these will be returned to the game. It will be appreciated that, while the step of providing an offer to the user appears near the end of the game in the preferred embodiment, it is in the scope of the invention to provide the user with an offer at any point in the game, or multiple offers during the game, based upon any combination of considerations discussed herein.

Referring back to FIG. 2, once the offer has been provided to the user as shown in Step 138, or if Step 134 determines that no offer is to be given to the user, the game advances to Step 144 where the user is offered a chance to provide an e-mail for a friend so that the friend can be notified about the game. These e-mails are meant to encourage viral game play, but they also contain marketing information that is useful to the company. The number of e-mails forwarded for a particular game may be an indicator of the effectiveness (viralness) of the brands presented in the game. The game can then use an index that compares the performance of different brands that are featured in different games, or in the same game. This data has a value at a micro level in providing feedback about how to design the game that is more viral and effective. Additionally, it has value at a macro level in assessing the effectiveness of a company's brand and its equity. Advantageously, this data is gathered from real consumers in their natural interaction with the brand.

Referring back to FIG. 2, as described above, advancing from Step 144, the next step is to record the user's response in the offer to notify friends of the game in Step 146. As shown in Step 148, this response data is recorded in the database 24 for later processing in a manner as described above. Advancing from Step 146, the game proceeds to Step 150 where the procedure according to a present exemplary embodiment of the invention has been completed (this portion of the game ends).

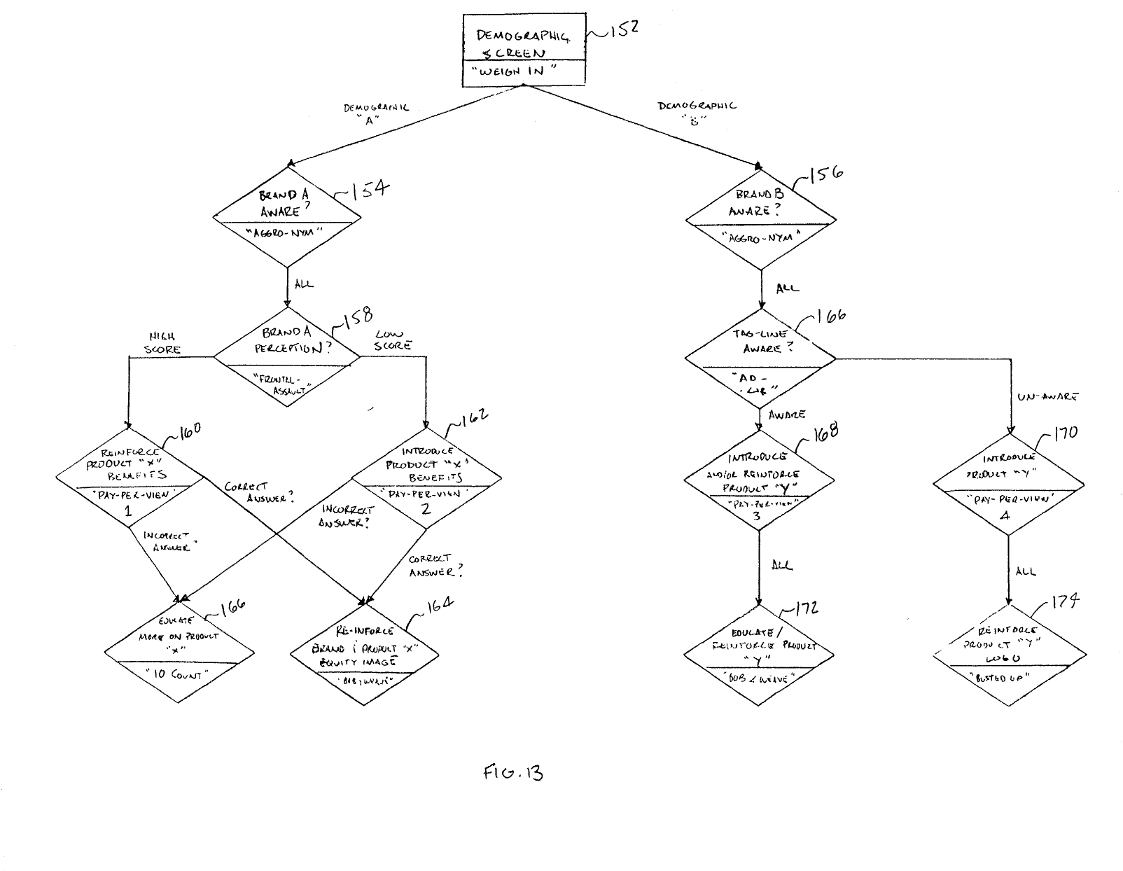

The exemplary embodiment of the game is designed such that the companies are able to customize their puzzles and define the flow of the game and the rules determining that flow. FIG. 13 provides a flow diagram illustrating an example rule set that may be established by a company for a particular game. At Step 152, the company may first want to obtain demographic information from the user at the beginning of the game. Therefore, the company will elect to present the “Weigh In” screen to the user. The company will then establish a rule based upon at least certain demographic information provided by the user on the “Weigh In” screen. For users fitting within demographic “A” the game will branch to Step 154 and target the players in this demographic to brand “A”, and for users fitting into demographic “B”, the game will branch to Step 156 and target the players in this demographic to brand “B”. In Step 154, the company will test to see if the user is aware of brand “A” by providing the “Aggro-Nym” puzzle (see FIG. 4 and associated discussion) to the user. Regardless of the user's interactions with the “Aggro-Nym” puzzle, the company will have the user advanced to Step 158 in which the company will test the user's perception of brand A utilizing the “Frontal Assault” puzzle (see FIG. 5 and associated discussion). If the user obtains a high score in the Frontal Assault puzzle, the company will have the game advanced to Step 160, where the company will have the game reinforce product “X” benefits for brand A by providing the user with one of four “Pay Per View” puzzles (see FIG. 8 and associated discussion); and if the user obtains a low score, the company will have the game advanced to Step 162, where the company will introduce the user to product “X” benefits by providing the user with a second of the four “Pay Per View” puzzles. In either of the two “Pay Per View” puzzles of Steps 160 or Step 162, if the user gets a correct answer, the defined rules will advance the user to Step 164 where company will reinforce the brand and product “X” equity image by providing the “Bob and Weave” puzzle (see FIG. 10 and associated discussion); and if the user answers the questions incorrectly, the company-defined rules will have the game advance to Step 166, where the company will attempt to educate the user more on product “X” by providing the “Ten Count” puzzle (see FIG. 9 and associated discussion).

If the user in Step 152 was determined in demographic B and the game advanced to Step 156, the company will test the user's awareness of brand B by utilizing the “Aggro-Nym” puzzle. Regardless of the user's performance with this puzzle, the user will then advance to Step 168 where the company will test to see if the user is aware of a certain tag line associated with brand B by utilizing the “Ad-Lib” puzzle (see FIG. 7 and associated discussion). The company-defined rules will then send users aware of the tag line to Step 168, where the company will introduce and/or reinforce product “Y” of brand “B” by providing the user with the third of four “Pay Per View” puzzles; and will send users unaware of the tag line Step 170, where the company will attempt to introduce product “Y” to the user by providing the fourth of the four “Pay Per View” puzzles. From Step 168, all users will then be taken to Step 172 where the company will attempt to educate or reinforce the product “Y” by providing the “Bob and Weave” puzzle (see FIG. 10 and associated discussion). From Step 170 the company will attempt to reinforce the product logo of product “Y” to the users by providing the “Busted Up” puzzle (see FIG. 11 and associated discussion) in Step 174.

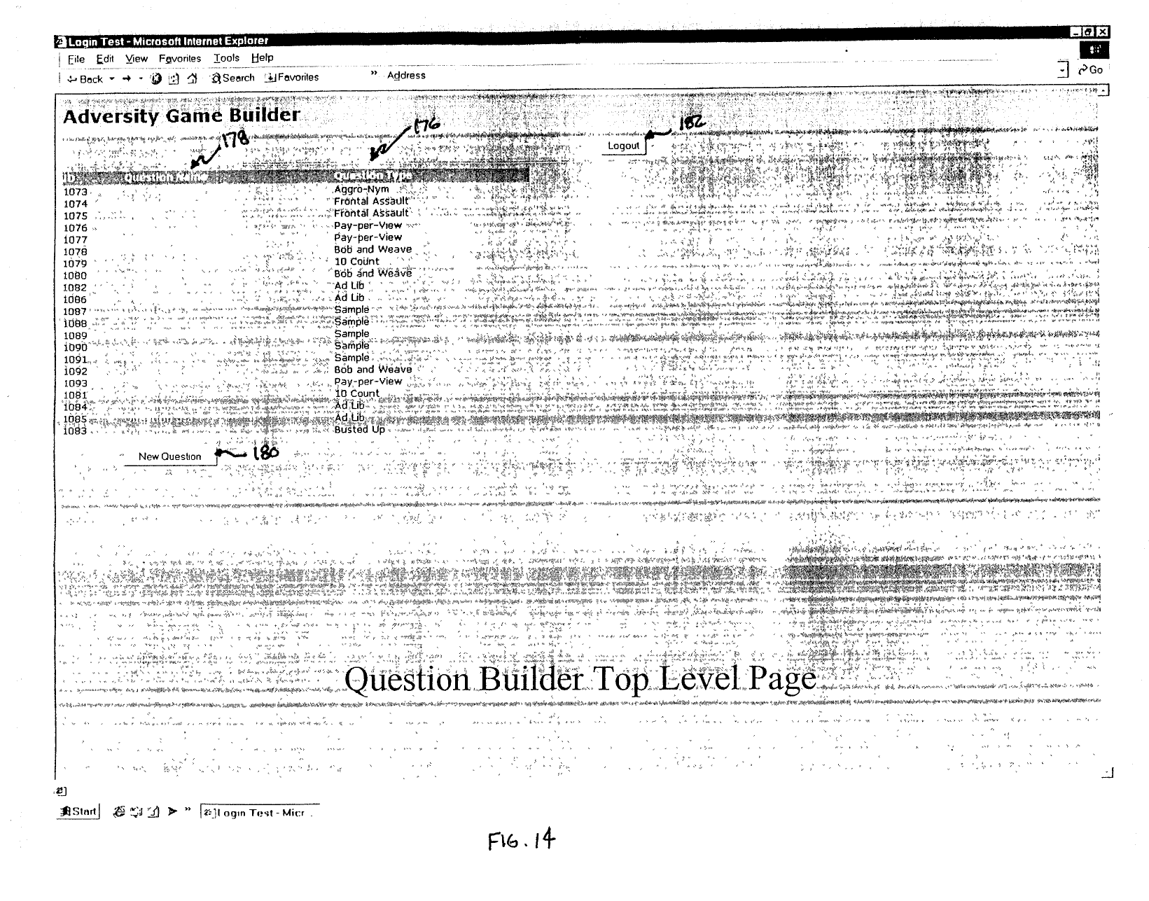

FIGS. 14-17 provide example screens of a software utility provided to the companies for defining the rules of a particular game and for constructing individual puzzles presented within the particular game. FIG. 14 provides an example screen listing the different puzzles (Column 176) set up by the company along with the different levels of the game (Column 178) that such puzzles will be presented to the user. For example, question 1.0 corresponds to a puzzle that will be provided on Level 1, question 2.0 and question 2.1 correspond to two questions that will be provided to different consumers on Level 2, and so forth. As an illustration, referring to back to FIG. 13, Steps 154 and 156 may be considered to reside in Level 1, Steps 158 and 166 may be considered to reside in Level 2, and so forth.

Referring again to FIG. 14, a button 180 is also provided that the company representative can activate if he or she wishes to define a new question for the particular game. Button 182 is provided to allow the company's representative to log out of the game builder software utility.

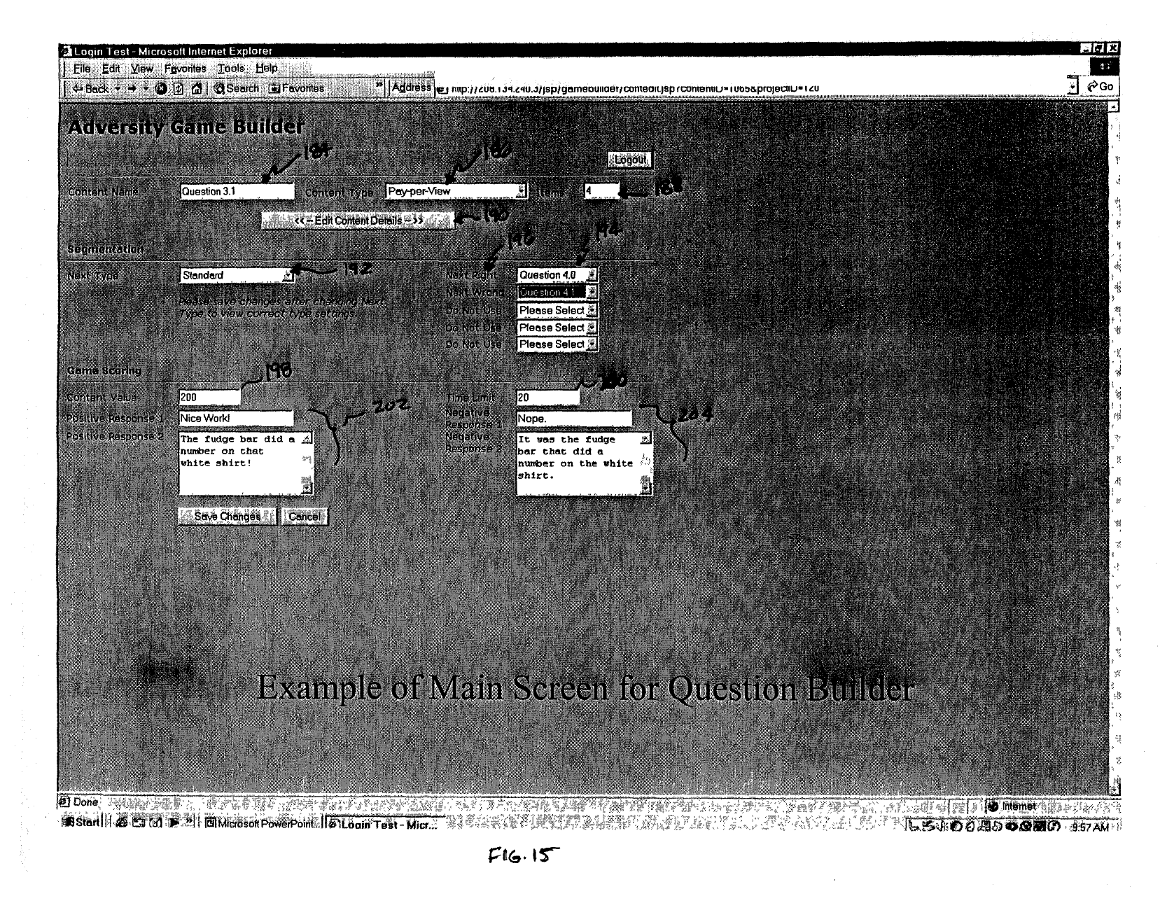

FIG. 15 provides an example form provided by the game builder utility in which the company's representative is able to define a particular puzzle that will be presented to the user. Field 184 defines the level of the present puzzle, Field 186 allows the company's representative to select the type of puzzle that is to be provided from a pull-down menu, and Field 188 provides the number of elements the user will solve or pick from within the particular puzzle, if necessary. The form also includes a button 190 that the company's representative can activate to open another form in which the company's representative can edit the content details of the game selected in Field 186.

Field 192 is a pull-down menu that allows the company's representative to select the rule-type that determines the next puzzles, if any, that will be provided based upon the user's performance with the present puzzle, the user's performance with previous puzzles, the user's demographic data, or a combination of any of these. Field 194 provides a plurality of pull-down menus that allow the user to select the next puzzle, if any, based upon an outcome 196 specified in front of the respective pull-down menu. Fields 194 & 196 will be different for each rule-type selected. In the exemplary embodiment, the selectable rule-types include:

“Standard”: Allows the company's representative to direct the user to a first puzzle if the user gets the present puzzle correct and to a second puzzle if the user gets the present puzzle incorrect (note that the first and second puzzles may be the same).

“Weight Class”: Allows the company's representative to direct the user to a particular puzzle based upon which demographic weight class was selected by the user in the Weigh In screen (FIG. 3). For example, there will be a pull-down menu 194 for each available selection of the user's weight class as will be indicated in the corresponding outcome field 196.

“Pets”: Allows the company's representative to direct the user to a particular puzzle based upon the pet selected by the user in the Weigh In screen.

“Age”: Allows the company's representative to direct the user to a particular puzzle based upon the age-range selected by the user in the Weigh In screen.

“Gender”: Allows the company's representative to direct the user to a particular puzzle based upon the user's sex selected in the Weigh In screen.

“A, B or Else”: Applies primarily to puzzles with multiple elements to solve, such the “Aggro-Nym” puzzle. This rule-type allows the company's representative to specify two of the elements in the puzzle (A & B), and if the user gets either element (A or B) correct, then the user will be directed to a first puzzle, otherwise (Else) the user will be directed to a second puzzle.

“A and B, Right, Wrong”: Applies primarily to puzzles with multiple elements to solve, such the “Aggro-Nym” puzzle. This rule-type allows the company's representative to specify two of the elements in the puzzle (A & B), and if the user gets both elements (A & B) correct, then the user will be directed to a first puzzle and if the user gets both elements (A & B) wrong, the user will be directed to a second puzzle.

It will be apparent to those of ordinary skill in the art that many different rule-types may be utilized and provided in the pull-down menu 192 in addition to the rule types above. Such alternate rule-types can be defined to direct a user to a puzzle or an alternate game path or outcome based upon any combination or logical comparison of the user's performance with any given puzzle or combination of puzzles, any combination or logical comparison of the user's demographic data, and any combination or logical comparison of performance and demographic data.

Field 198 allows the company's representative to specify how many points are at stake in the game's overall theme for this puzzle and Field 200 allows the company's representative to specify a time limit for the user to solve this puzzle. Field 202 allows the company's representative to define the textual displays for the congratulatory screen and Field 204 allows the company's representative to define the textual displays for the incorrect answer screen.

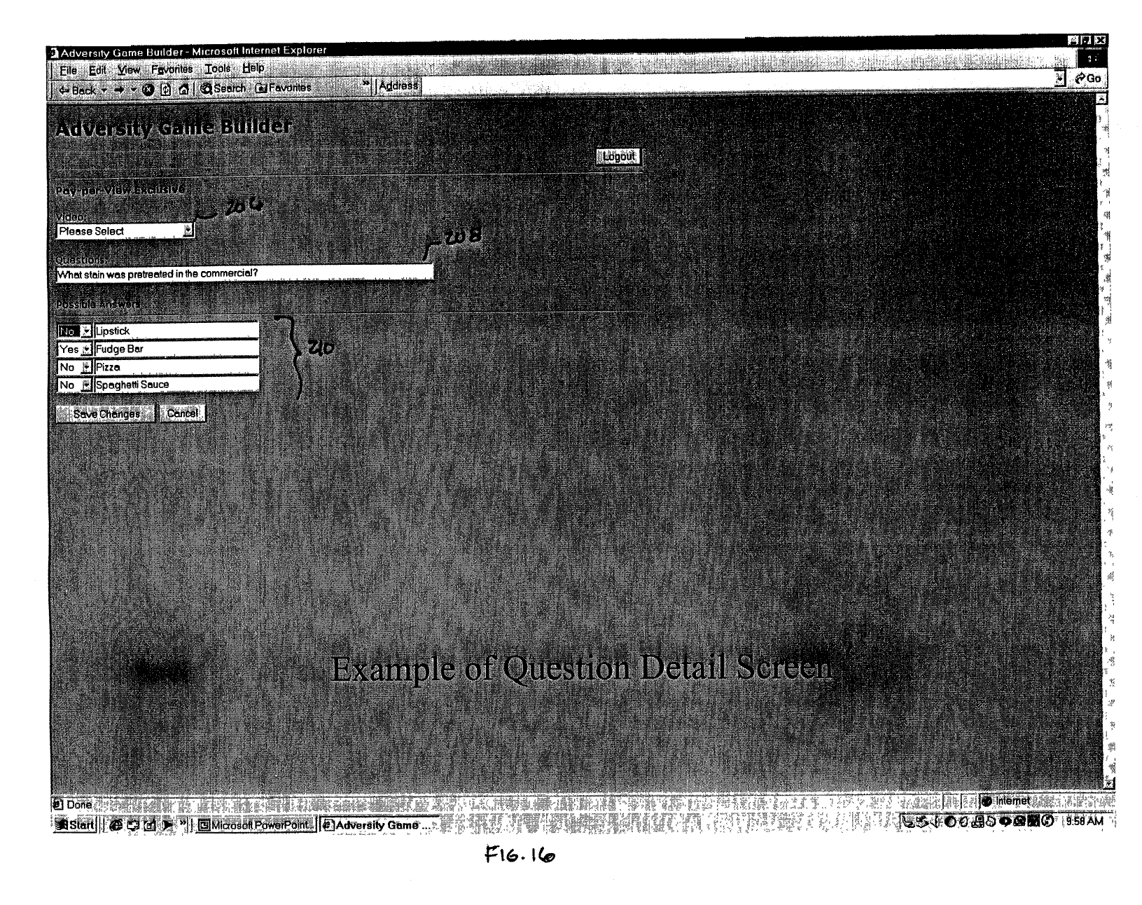

FIG. 16 provides an example puzzle-content details form provided by the game builder utility upon the user activating the “Edit Content Details” button in the form illustrated in FIG. 15. This form allows the user to define the precise content of the actual puzzle selected by the user in Field 186 in FIG. 15 and will be different depending upon the type of puzzle selected. The present example illustrated in FIG. 16 allows the user to define the content of the puzzle screen for the “Pay Per View” puzzle selected by the user in FIG. 15. Field 206 is a pull-down menu that allows the company's representative to select the video (i.e., commercial) to be displayed in the “Pay Per View” puzzle from a plurality of available videos. Field 208 allows the company's representative to define the question that will be asked of the user upon displaying the selected video and Field 210 allows the company's representative to define the possible answers, and which of the possible answers are correct. The Content Details forms for the other available puzzles will be set up in a similar fashion, the available designs of which will be apparent to those of ordinary skill in the art.

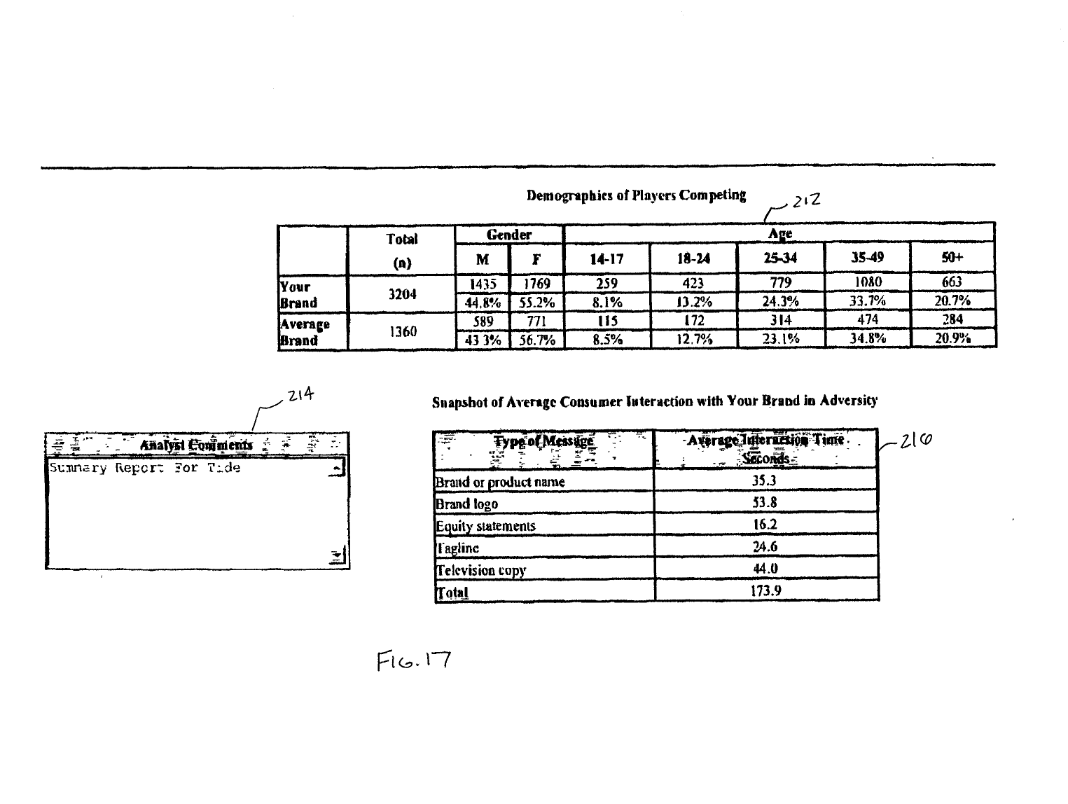

FIGS. 17-21 provide examples of various statistical reports that could be fashioned from the demographic and performance data stored in the database 24 as a result of a number of users playing the game according to the present invention. FIG. 17 illustrates an example report summarizing a company's brand performance within the game as compared to other brands supported by the game. In the table labeled “Demographics of Players Competing” 212, the demographics of the various players are illustrated. In this example, of the 3,204 total players, 1,435 were male, 1,769 were female, 259 were aged 14-17, 423 were aged 18-24, 779 were aged 25-34, 1,080 were aged 35-49 and 663 were over the age of 50. The table labeled “Analyst's Comments” 214 is an area in which an analyst can provide comments with respect to the illustrated statistics. In the table labeled “Snap Shot of Average Consumer Interaction with Your Brand” 216, the average interaction time of the users is provided for the brand or product name, the brand logo, equity statements, tag lines, television copy and overall total.

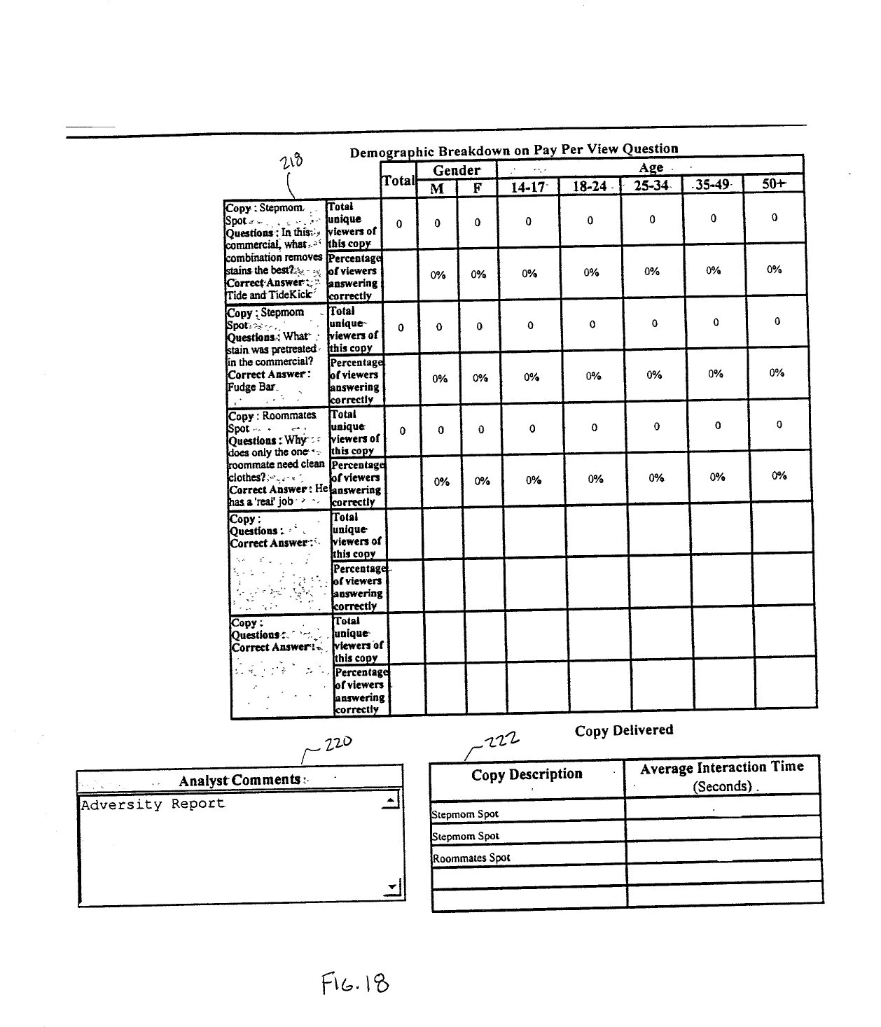

FIG. 18 provides an example report for a statistical analysis of the “Pay Per View” puzzles provided within a particular game. The table labeled “Demographic Breakdown of Pay Per View Question” 218 provides a row for each Pay Per View puzzle utilized by the game. And for each of the Pay Per View questions utilized by the game, statistics are given for the total number of players, total number of male players, total number of female players, total numbers of players aged 14-17, total number of players aged 18-24, total number of players aged 25-34, total number of players aged 35-49, and total number of players over the age of 50. In addition, for each of these player categories, the percentage of the players answering the question correctly is provided. In the exemplary embodiment, this table 218 only provides statistics of “unique viewers”, which are players accessing the particular Pay Per View Question a first time within a particular time period, such as the first time accessed within a particular month. The game is able to determine this “unique viewer” status based upon a flag established in the database entry for the viewer or upon the game reviewing similar data in “cookies” stored on the player's computer. Another table 220 is provided for analysts' comments and a table 222 is provided to show the average interaction time for each of the available Pay Per View puzzles.

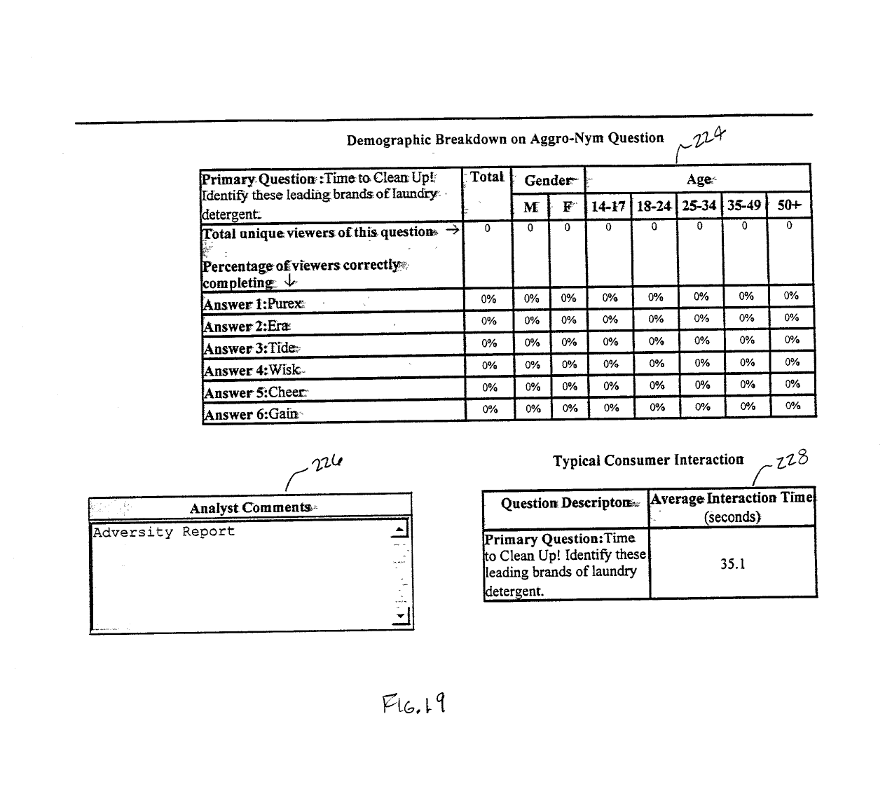

FIG. 19 provides another example of a statistical breakdown for the player's performance with respect to the “Aggro-Nym” puzzle. Table 224 provides a demographic breakdown of the total unique viewers to the puzzle for each demographic and which of the viewers correctly completed the respective fill-in-the-blank answers for each available brand. Viewing this table, therefore, the company can determine how many of the viewers were capable of recognizing its brand versus its competitor's brands and can also break down this statistic among the demographics provided. Table 226 provides an area for an analyst to enter his or her comments and Table 228 provides the average interaction time for this puzzle.

The reports described above are only examples of a multitude of different reports that can be provided based upon the statistical data collected in database 24; all of which are within the scope of the present invention. Furthermore, the delivery of the reports can be made to the company and to any other desired entity in any available manner as is known to those of ordinary skill in the art.

Having described the invention by reference to its exemplary embodiments, it will be clear to those of ordinary skill that modifications and improvements can be made to the exemplary embodiments disclosed herein without departing from the scope of the invention as defined in the claims. Additionally, the inventions disclosed herein are defined by the claims and it is not intended that any limitations from this disclosure be read into the claims unless expressly required by the language of the claims themselves. Additionally, it will be apparent to those of ordinary skill in the art that, while many objects and advantages of the present invention are disclosed herein, there may be many inherent advantages of the invention that have not been expressly discussed. Accordingly, it is not necessary to meet any of the stated objects of the invention disclosed herein to follow within the scope of any of the claims.

What is claimed is:

1. A computerized method for providing advertising to a consumer and/or for gathering statistical data from the consumer associated with a commercial entity's products and/or services, comprising the steps of:
providing a computerized game to a consumer, the game including the step of testing the consumer's ability to recognize a marketing object associated with the commercial entity, the marketing object taken from a group consisting of: the commercial entity's logo, the commercial entity's trademark, the commercial entity's tradename, the commercial entity's tag line, the commercial entity's product name, a competitor's logo, a competitor's trademark, a competitor's tradename, a competitor's tag line and a competitor's product name.

2. The computerized method of claim 1, wherein the testing step includes the step of providing a computerized puzzle for the consumer to solve.

3. The computerized method of claim 2, wherein the computerized puzzle involves a puzzle taken from a group consisting of:
a fill-in-the-missing-letters type word game;
an unscramble-the-letters type word game;
a multiple-choice type question;
a true-false type question;
a fill-in-the-blank type question;
a game testing the user's ability to assemble a finished image from a plurality of scrambled partial-images;
a game testing the user's ability to recognize a marketing object from a partial image of the marketing object;
a concentration style memory matching game; and
a game testing the consumer's ability to recognize marketing objects associated with the commercial entity versus marketing objects not associated with the commercial entity.

4. The computerized method of claim 3, wherein the game includes a plurality of computerized puzzles and the consumer is provided with a series of the plurality or the computerized puzzles.

5. The computerized method of claim 4, wherein the game includes the step of selecting a next of the plurality of puzzles in the series to be provided to the consumer based, at least in part, upon the performance of the consumer in one or more previous puzzles.

6. The computerized method of claim 5, wherein the game includes the step of selecting a next of the plurality of puzzles in the series to be provided to the consumer based, at least in part, upon demographical information of the consumer.

7. The computerized method of claim 6, further comprising the step of storing the puzzle-solving performance of the consumer for at least one of statistical analysis and report generation.

8. The computerized method of claim 5, further comprising the step of delivering one of a plurality of marketing messages to the consumer based, at least in part, upon the puzzle-solving performance of the consumer.

9. The computerized method of claim 8, wherein the step of delivering one of a plurality of marketing messages to the consumer is also based, at least in part, upon demographic information of the consumer.

10. The computerized method of claim 5, further comprising the step of offering at least one of a coupon, a product sample, a loyalty program and a gift based, at least in part, upon the puzzle-solving performance of the consumer.

11. The computerized method of claim 5, further comprising the step of offering at least one of a coupon, a product sample, a loyalty program and a gift based, at least in part, upon a combination of the puzzle-solving performance of the consumer and demographic information of the consumer.

12. The computerized method of claim 4, wherein the game includes the step of selecting a next of the plurality of puzzles to be provided to the consumer based, at least in part, upon demographical information of the consumer.

13. The computerized method of claim 2, further comprising the step of storing the puzzle-solving performance of the consumer for at least one of statistical analysis and report generation.

14. The computerized method of claim 2, further comprising the step of delivering one or more of a plurality of marketing messages to the consumer based, at least in part, upon the puzzle-solving performance of the consumer.

15. The computerized method of claim 2, further comprising the step of delivering one or more of a plurality of marketing messages to the consumer based, at least in part, upon a combination of puzzle-solving performance of the consumer and demographic information of the consumer.

16. The computerized method of claim 2, further comprising the step of offering at least one of a coupon, a product sample, a loyalty program and a gift based, at least in part, upon the puzzle-solving performance of the consumer.

17. The computerized method of claim 2, further comprising the step of offering at least one of a coupon, a product sample, a loyalty program and a gift based, at least in part, upon a combination of the puzzle-solving performance of the consumer and demographic information of the consumer.

18. The computerized method of claim 2, further comprising the step of, upon a consumer failing to solve the puzzle, providing a correct answer along with one or more of a visual marketing message, a marketing image, an audio marketing message, and a video of a marketing message.

19. The computerized method of claim 18, wherein the step of providing the correct answer along with one or more of a visual marketing message, a marketing image, an audio marketing message, and a video of a marketing message includes the step of integrating the correct answer with the one or more of the visual marketing message, the marketing image, the audio marketing message, and the video of a marketing message provided to the consumer.

20. The computerized method of claim 5, further comprising a step of providing a real-time, cumulative indication to the consumer indicative of the consumer's puzzle-solving performance.

21. The computerized method of claim 5, further comprising the step of selecting a content of the next of the plurality of puzzles in the series to be provided to the consumer based, at least in part, upon the performance of the consumer in one or more previous puzzles.

22. The computerized method of claim 5, further comprising the step of selecting a content of the next of the plurality of puzzles in the series to be provided to the consumer based, at least in part, upon demographical information of the consumer.

23. The computerized method of claim 5, further comprising the step of selecting a content of the next of the plurality of puzzles in the series to be provided to the consumer based, at least in part, upon a combination of the performance of the consumer in one or more previous puzzles and demographical information of the consumer.

24. The computerized method of claim 2, further comprising the step of presenting the puzzle to the consumer with one or more of an associated visual marketing message, an associated marketing image, an associated audio marketing message, and an associated video of a marketing message that is provided to the consumer.

25. The computerized method of claim 2, including the steps of:
providing the ability for the consumer to notify other consumers about the computerized game; and
assessing how viral the game is and/or how viral a marketing object is depending, at least in part, upon how many other consumers have been notified.

26. The computerized method of claim 1, wherein the step of providing a computerized game to the consumer includes the step of providing the computerized game to the consumer utilizing, at least in part, interactive electronic media.

27. The computerized method of claim 26, wherein the interactive electronic media utilizes delivery and access of the game over the World-Wide-Web.

28. The computerized method of claim 26, wherein the interactive electronic media is interactive television.

29. The computerized method of claim 26, wherein the interactive electronic media is a standalone computer system.

30. The computerized method of claim 26, wherein the interactive electronic media is a telephone system.

31. The computerized method of claim 1, including the steps of:
obtaining demographic information from the consumer; and
controlling at least certain aspects of the game according to at least a portion of the demographic information provided by the consumer.

32. The computerized method of claim 1, including the steps of:
obtaining demographic information from the consumer;
storing game performance data of the consumer in accordance with at least a portion of the demographic information provided by the consumer.

33. A computerized method for measuring a consumer's perception of a commercial entity's brand equity, logo, trademark, tradename, tag line, product name and the like, comprising the steps of:
providing a present interactive advertising message to the consumer;
allowing the consumer to interact with the present interactive advertising message;
gathering data associated with the consumer's interactions with the present interactive advertising message.

34. The computerized method of claim 33, wherein the present interactive advertising message is provided to a computer accessible by the consumer, the computer having a display screen and an input device.

35. The computerized method of claim 33, wherein the present interactive advertising message is provided to a display device accessible by the consumer, the display device having an associated input device.

36. The computerized method of claim 33, including the step of obtaining demographic information pertaining to the consumer.

37. The computerized method of claim 36, wherein the step of providing the present interactive advertising message to the consumer includes the step of selecting the present interactive advertising message from a group of interactive advertising messages based, at least in part, upon at least a portion of the demographic information obtained for the consumer.

38. The computerized method of claim 37, further comprising the steps of:
selecting a next interactive advertising message based, at least in part, upon at least a portion of the data associated with the consumer's interactions with the present interactive advertising message; and
providing the next interactive advertising message to the consumer.

39. The computerized method of claim 38, further comprising the step of gathering data associated with the consumer's interactions with the next advertising message.

40. The computerized method of claim 37, further comprising the steps of:
selecting a next interactive advertising message based, at least in part, upon a combination of at least a portion of the data associated with the consumer's interactions with the present interactive advertising message and at least a portion of the demographic information obtained for the consumer; and
providing the next interactive advertising message to the consumer.

41. The computerized method of claim 40, further comprising the step of gathering data associated with the consumer's interactions with the next advertising message.

42. The computerized method of claim 33, wherein the present interactive advertising message is provided within the context of an interactive game.

43. The computerized method of claim 33, further comprising the steps of:
selecting a next interactive advertising message based, at least in part, upon the consumer's interactions with the present interactive advertising message; and
providing the next interactive advertising message to the consumer.

44. The computerized method of claim 33, wherein the step of gathering data associated with the consumer's interactions with the present advertising message, includes the step of gathering data related to the consumer's awareness of the commercial entity's brand.

45. The computerized method of claim 33, wherein the step of gathering data associated with the consumer's interactions with the present advertising message, includes the step of gathering data related to the consumer's awareness of the commercial entity's product.

46. The computerized method of claim 33, wherein the step of gathering data associated with the consumer's interactions with the present advertising message, includes the step of gathering data related to the consumer's recall of the commercial entity's tagline.

47. The computerized method of claim 33, wherein the step of gathering data associated with the consumer's interactions with the present advertising message, includes the step of gathering data related to the consumer's recall of the benefit of the commercial entity's product/service.

48. The computerized method of claim 33, wherein the step of gathering data associated with the consumer's interactions with the present advertising message, includes the step of gathering data related to the consumer's image association with the commercial entity's brand equity.

49. The computerized method of claim 33, wherein the step of gathering data associated with the consumer's interactions with the present advertising message, includes the step of gathering data related to the consumer's language association with the commercial entity's brand equity.

50. A computerized method for measuring a consumer's perception of a commercial entity's brand equity, logo, trademark, tradename, tagline, product name and the like, comprising the steps of:
providing an interactive puzzle to a user's computer terminal having at least a display and a user-controlled input device, the interactive puzzle testing the user's perception regarding one or more items taken from a group consisting of: a commercial entity's brand equity, a commercial entity's logo, a commercial entity's trademark, a commercial entity's tradename, a commercial entity's tagline, a commercial entity's product name, benefits of a commercial entity's product, a commercial entity's service name, and benefits of a commercial entity's service;
monitoring the user's interactions with the interactive puzzle; and
based upon the user's interactions with the interactive puzzle performing one or more of the following steps,
providing a next interactive puzzle to the user's computer;
providing an advertising message to the user's computer; and
offering to the user at least one of a coupon, a product sample, a loyalty program and a gift.

51. The method of claim 50, wherein the interactive puzzle is one of a fill-in-the-missing-letters type word game and a unscramble-the-letters type word game.

52. The method of claim 51, wherein the word game operates according, at least in part, to the step of providing a plurality of phrases consisting of at least one word for the user to fill-in or unscramble, respectively, wherein at least one of the phrases corresponds to the commercial entity and wherein at least one of the phrases corresponds to a competitor of the commercial entity.

53. The method of claim 52, wherein the plurality of phrases include different brands in a category of products/services.

54. The method of claim 52, wherein the plurality of phrases include different products in a product line.

55. The method of claim 50, wherein the interactive puzzle operates, at least in part, according to the steps of:
displaying one or more items to the user; and
querying the user whether or not the item pertains to the commercial entity.

56. The method of claim 55, wherein the item displayed to the user is a phrase consisting of one or more words.

57. The method of claim 56, wherein the phrase is one of a trademark, a service mark, a product name, a service name and a tagline of the commercial entity.

58. The method of claim 55, wherein the item displayed is an image.

59. The method of claim 58, wherein the image is one of the commercial entity's logo, a product of the commercial entity and an equity image pertaining to the commercial entity.

60. The method of claim 50, wherein the interactive puzzle operates, at least in part, according to the step of providing a question to the user.

61. The method of claim 60, wherein the operation of the puzzle further includes the step of providing at least one of an audio message, a video message and an image to the user and the question provided to the user pertains to the one of the audio message, video message and image provided.

62. The method of claim 61, wherein the one of the audio message, video message and image is an advertisement.

63. The method of claim 61, wherein the one of the audio message, video message and image is a partial segment of a complete one of an audio message, video message and image.
